(19) United States
(12) Patent Application Publication
(10) Pub. No.: US 2018/0278823 A1
(43) Pub. Date: Sep. 27, 2018

(54) AUTO-EXPOSURE TECHNOLOGIES USING ODOMETRY

(71) Applicant: Intel Corporation, Santa Clara, CA (US)

(72) Inventor: NIZAN HORESH, Caesarea (IL)

(73) Assignee: Intel Corporation, Santa Clara, CA (US)

(21) Appl. No.: 15/467,479

(22) Filed: Mar. 23, 2017

(51) Int. Cl. H04N 5/235; H04N 5/14

(52) U.S. Cl. CPC H04N 5/2351; H04N 5/145

(57) ABSTRACT

An odometric image capture system includes an image acquisition device that provides an image to exposure determination circuitry and motion prediction circuitry at current time=t₁. One or more odometric sensors provide data representative of a first pose and movement or displacement of the odometric image capture system through a three-dimensional space. The motion prediction circuitry predicts a second pose and/or location of the odometric image capture system at a future time=t₂ and also provides a prospective second image based on the second pose and/or location to the exposure determination circuitry. The exposure determination circuitry determines one or more exposure parameters using the prospective second image and communicates the exposure parameters to the image acquisition device prior to future time=t₂.

### TECHNICAL FIELD

The present disclosure relates to technologies for generating auto-exposure parameters.

### BACKGROUND

Auto-exposure is a feature of many digital image acquisition devices, and is generally a process by which exposure settings (e.g. shutter speed, aperture, sensitivity, and gain) are automatically adjusted to capture a balanced image in which the image pixel intensity distribution is spread across a desired dynamic range. In some instances, the image acquisition device may employ an auto-exposure algorithm to interactively generate exposure parameters. For example, some auto-exposure processes involve capturing a first image, analyzing the first image using image processing techniques to determine one or more exposure parameters, and capturing a second image using the one or more exposure parameters. The convergence time of the auto-exposure process (i.e., the elapsed time between when the first image is captured to the determination of the one or more exposure parameters) is one measure of the performance of a digital camera. If the convergence time is relatively slow, image information may be lost as the image acquisition device passes quickly across a scene.

Other factors may also impact the accuracy and/or effectiveness of known auto-exposure methods. For example, digital cameras often capture images with a dynamic range that is significantly smaller than the dynamic range of the scene. Consequently, incomplete information about a scene may be used by some auto-exposure algorithms to determine exposure parameters. Similarly, in some applications restricted exposure values (e.g., anti-flicker), convergence without oscillations, etc. may be desirable or even necessary. In those and other instances, current auto-exposure methods may determine, select, or otherwise choose less than optimal or undesirable exposure parameters, potentially resulting in the loss of information about a scene.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 is an example odometric image capture system that includes an image acquisition device, exposure determination circuitry, motion prediction circuitry, and one or more odometric sensors, in accordance with at least one embodiment of the present disclosure;

FIG. 2 is an example system in which a odometric image capture system displaced or otherwise translated through a three-dimensional system acquires a current image of a scene at time=t₁ and in which the motion prediction circuitry determines a prospective second image of the scene at a future time=t₂, in accordance with at least one embodiment described herein;

FIG. 3 is an example processor-based apparatus or device that includes a odometric image capture system, in accordance with at least one embodiment described herein;

FIG. 4A is an example current first image acquired by a odometric image capture system at a current first time=t₁, in accordance with at least one embodiment described herein;

FIG. 4B is an example prospective or future second image acquired by the odometric image capture system at a future second time=t₂ overlaid on the illustrative current first image depicted in FIG. 4A, in accordance with at least one embodiment described herein;

FIG. 4C is another example prospective or future second image acquired by the odometric image capture system at a future second time=t₂ overlaid on the illustrative current first image depicted in FIG. 4A, in accordance with at least one embodiment described herein;

FIG. 5 is a logic flow diagram of an illustrative odometric image capture method, in accordance with at least one embodiment described herein; and

FIG. 6 is a logic flow diagram of an illustrative odometric image capture method, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The systems, methods, and apparatuses disclosed herein use odometry to both predict a position of an image acquisition device at a future time and determine appropriate exposure settings at the future time using the content of a prospective image acquired by the image acquisition device at the future time. The systems, methods, and apparatuses disclosed herein provide the data used in determining appropriate image acquisition device exposure settings or parameters to be used in capturing a prospective future scene based on the location and motion of the image acquisition device. The systems, methods, and apparatuses disclosed herein generate such data using odometric principles to determine a future location of the image acquisition device based on the current location and measured motion or displacement of the image acquisition device.

Odometry is the use of motion, movement, or displacement information to determine the change in position of an object over time. Using odometric principles, it is possible to estimate or predict the future location of an object, such as an image acquisition device, based on the current location of the device and the movement, motion, or displacement of the device through a three-dimensional space. Applying odometric principles to data provided by motion sensors carried by an image acquisition device, the future location, direction, and field-of-view of the image acquisition device may be estimated or predicted. Once the prospective content of the future field-of-view of the image acquisition device is determined, auto-exposure algorithms may be used to predict the exposure values for future images (e.g., the next image frame at a given frame rate), thereby beneficially and advantageously reducing the time for achieving an optimal exposure.

Using data associated with an initial (or first) pose of the image acquisition device and the motion or displacement of the image acquisition device in a three-dimensional space at a first time=t₁, the content of a prospective image obtained at a future time=t₂ may be estimated. For example, by extrapolating one or more parameters from an edge of the current image to the edge of the prospective future image. Since changes in image acquisition device field-of-view typically occur more slowly than the frame rate of the image acquisition device, such future image data extrapolation may represent only a small portion of the overall prospective future image content.

A system for generating odometric auto-exposure information is provided. The system may include: an image acquisition device; one or more odometric sensors to provide odometric data; processor circuitry communicably coupled to the image acquisition device and to the one or more odometric sensors. The processor circuitry may include: motion prediction circuitry; and exposure determination circuitry. The system may additionally include: a storage device that includes one or more instruction sets that, when executed by the processor circuitry cause the processor circuitry to, at a first time (t₁), cause the image acquisition device to acquire data representative of a first image within a field-of-view of the image acquisition device; cause the motion prediction circuitry to generate data indicative of a first pose of the image acquisition device in a three-dimensional space; cause the motion prediction circuitry to acquire odometric data indicative of a displacement of the image acquisition device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image; and, at the second time t₂, cause the image acquisition device to acquire data representative of a second image using the at least one determined auto-exposure parameter.

An odometric auto-exposure controller is provided. The controller may include processor circuitry to, at a first time (t₁), cause a communicably coupled image acquisition device to acquire data representative of a first image within a field-of-view of the image acquisition device; cause motion prediction circuitry to generate data indicative of a first pose of the image acquisition device in a three-dimensional space; cause the motion prediction circuitry to acquire odometric data indicative of a displacement of the image capture device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image, and at the second time t₂, cause the image acquisition device to acquire data representative of a second image using the at least one determined auto-exposure parameter.

An odometric auto-exposure method is provided. The method may include: acquiring, at a first time (t₁), data representative of a first image in a first field-of-view of an image acquisition device; generating, at t₁, data indicative of a first pose of the image capture device in a three-dimensional space; acquiring, at t₁, odometric data indicative of a displacement of the image capture device in the three dimensional space; generating data indicative of a predicted second pose of the image acquisition device in the three-dimensional space at a second time (t₂); generating data representative of a prospective second image within a second field-of-view using the data representative of the predicted second pose of the image capture device; determining at least one auto-exposure parameter using the generated data representative of the prospective second image; and acquiring, at t₂, data representative of a second image using the image capture device and the one or more determined auto-exposure parameters.

A non-transitory computer readable medium that includes one or more instruction sets that when executed by processor circuitry cause the processor circuitry to provide an odometric image capture system. The non-transitory computer readable medium that includes one or more instruction sets that cause the processor circuitry to: at a first time (t₁), cause a communicably coupled image acquisition device to acquire data representative of a first image within a field-of-view of the image acquisition device; cause motion prediction circuitry to generate data indicative of a first pose of the image acquisition device in a three-dimensional space; cause the motion prediction circuitry to acquire odometric data indicative of a displacement of the image capture device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image; and at the second time t₂: cause the image acquisition device to acquire data representative of a second image using the at least one determined auto-exposure parameter.

An odometric auto-exposure system is provided. The system may include: a means for acquiring data representative of a first image within a field-of-view of an image acquisition device at a first time (t₁); a means for generating data indicative of a first pose of the image acquisition device in a three-dimensional space at the first time; a means for acquiring odometric data indicative of a displacement of the image capture device in the three dimensional space; a means for generating data indicative of a predicted second pose of the image acquisition device in the three-dimensional space at a second time (t₂); a means for generating data representative of a prospective second image within a second field of view of the image acquisition device using the data representative of the predicted second pose of the image acquisition device; a means for determining at least one auto-exposure parameter using the generated data representative of the prospective second image; and a means for acquiring, at t₂, data representative of a second image using the at least one determined auto-exposure parameter.

As used herein the terms “top,” “bottom,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, the term “pose” refers to the physical orientation of a device within a three-dimensional space having a fixed coordinate system. For example, a device may have a first pose at a first time in which the principal axis of the device is aligned with the x-axis in a three-dimensional space defined by a Cartesian coordinate system. If the device is subsequently rotated along the z-axis, the device may have a second pose at a second time in which the principal axis of the device is aligned with the y-axis in the Cartesian coordinate system.

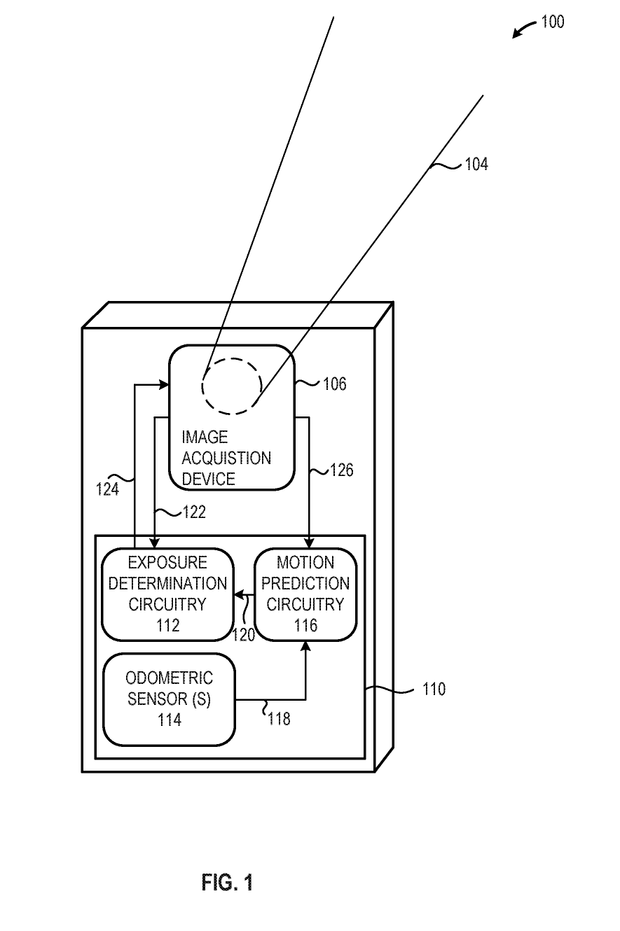

FIG. 1 depicts an example odometric image capture system 100 that includes an image acquisition device 106, exposure determination circuitry 112, motion prediction circuitry 114, and one or more odometry sensors 116, in accordance with at least one embodiment of the present disclosure. The image acquisition device 106 obtains an image of a scene in a field-of-view 104. In embodiments, the image acquisition device 106 selectively acquires the image data, for example in response to a user input. In some implementations, the image acquisition device 106 may sequentially capture a series of images at a fixed or variable frame rate. Example frame rates include, 5 frames per second (fps), 10 fps, 30 fps, 60 fps, 120 fps, 240 fps, or even higher.

The image acquisition device 106 acquires image data that includes objects and scenery within at least a portion of the field-of-view 104. The image acquisition device 106 may acquire image data within the visible electromagnetic spectrum (e.g., electromagnetic energy having wavelengths from about 390 nanometers to about 700 nanometers), within the ultraviolet (“UV”) electromagnetic spectrum (e.g., electromagnetic energy having wavelengths of less than 390 nanometers), within the infrared (“IR”) electromagnetic spectrum (e.g., electromagnetic energy having wavelengths of greater than 700 nanometers), or combinations thereof.

The image acquisition device 106 may include any current or future developed device, system, or combination of devices and/or systems capable of generating one or more output signals that carry or convey information and/or data representative of a scene within the field-of-view 104 of the image acquisition device 106. Example image acquisition devices include, but are not limited to, one or more charge-coupled device (CCD) sensors; one or more complementary metal-oxide-semiconductor (CMOS) sensors, one or more N-type metal-oxide-semiconductor (NMOS, Live MOS) sensors, or combinations thereof.

The image acquisition device 106 generates and transmits a first image signal 122 that carries or otherwise conveys information and/or data representative of an image to the exposure determination circuitry 112. The image acquisition device 106 may generate and transmit a second image signal 126 that carries or otherwise conveys information and/or data representative of an image to the motion prediction circuitry 114. In embodiments, the second image signal 126 may carry, transmit, or otherwise convey the same or different image information and/or data as carried, transmitted, or otherwise conveyed by the first image signal 122.

The exposure determination circuitry 112 provides an auto-exposure signal 124 to the image acquisition device 106. The auto-exposure signal 124 includes information and/or data representative of one or more exposure parameters that are calculated, determined, or otherwise obtained by the exposure determination circuitry 112. Example exposure parameters include, but are not limited to information and/or data indicative of: a desired aperture, a desired shutter speed, a desired sensitivity (e.g., ISO setting), a desired sensor gain, or combinations thereof.

In embodiments, the exposure determination circuitry 112 receives the first image signal 122 from the image acquisition device 106. Using the first image signal 122, the exposure determination circuitry 112 calculates, determines, or otherwise obtains one or more auto-exposure settings for the current scene within the field-of-view 104 of the image acquisition device 106 at current time=t₁.

In embodiments, the motion prediction circuitry 116 may provide a prospective image signal 120 that includes information and/or data representative of a prospective (i.e., future) image or scene within the field-of-view 104 of the image acquisition device 106 (e.g., the scene in the field of view at future time=t₂). Using the second image signal 122 provided by the motion prediction circuitry 116, the exposure determination circuitry 112 calculates, determines, or otherwise obtains one or more auto-exposure settings for a prospective image of a scene within the field-of-view 104 of the image acquisition device 106 at future time=t₂.

In some implementations, the exposure determination circuitry 112 may employ any number and/or combination of current or future developed exposure determination algorithms to calculate or otherwise determine at least some of the one or more auto-exposure settings included in the auto-exposure signal 124 communicated to the image acquisition device 106. In some implementations, the exposure prediction circuitry 112 may use at least some of the current scene auto-exposure settings for the prospective future scene auto-exposure settings. Such may occur, for example, when the prospective scene at future time=t₂ is the same or similar to the scene at current time=t₁ (e.g., when the image acquisition device 106 is held stationary from ti to t₂). In some implementations, the exposure determination circuitry 112 may look-up or otherwise retrieve at least some of the one or more auto-exposure settings from a data structure, data store, and/or database disposed in, on, or about a storage device communicably coupled to the exposure determination circuitry 112.

The odometric sensors 114 may include any number and/or combination of currently available and/or future developed sensors or sensor arrays capable of providing one or more odometric signals 118 to the motion prediction circuitry 116. The one or more odometric signals 118 may include information and/or data representative of the movement, motion, displacement, rotation, acceleration, velocity, and/or translation of the system 100 in a three-dimensional space. In some implementations, the one or more odometric sensors 114 may provide information and/or data indicative of the distance, direction, and/or path of the system 100 through the three-dimensional environment. The one or more odometric sensors may include, but are not limited to, one or more motion sensors, one or more accelerometers, one or more gyroscopic sensors, one or more geolocation sensors, one or more geo-positioning sensors, or combinations thereof. The one or more odometric sensors 114 may provide the one or more odometric signals 118 to the motion prediction circuitry 116 on a continuous, intermittent, periodic, or aperiodic basis. In embodiments, the update or refresh rate (i.e., the rate at which the information and/or data representative of motion of the odometric image capture system 100 included in the odometric signal 118 is updated) of the one or more odometric sensors 114 is greater than the frame rate of the image acquisition device 106.

The motion prediction circuitry 116 receives the second image signal 126 from the image acquisition device 106 and one or more odometric signals 118 from the one or more odometric sensors 114. Using the received odometric information and/or data indicative of the movement or motion of the system 100, the motion prediction circuitry 116 determines the future location of the system 100 in the three-dimensional space (i.e., the location of the system 100 in the three-dimensional space at future time=t₂). The motion prediction circuitry 116 may include any number and/or combination of configurable and/or hardwired electrical components, logic elements, and/or semiconductor devices arranged to generate a prospective image signal 120 that includes information and/or data representative of a prospective image of a future scene in the field-of-view 104 of the image acquisition device 106 at a future time t₂. The motion prediction circuitry 116 may include any combination of hardware devices capable of executing machine readable instruction sets supplied as either software or firmware.

Based on the predicted location of the system in the three-dimensional space at future time t₂, and using at least some of the received information and/or data representative of the current scene obtained or otherwise acquired by the image acquisition device 106, the motion prediction circuitry 116 generates information and/or data representative of a prospective second image in the field-of-view 104 of the image acquisition device 106 at future time=t₂. In implementations where the prospective second image includes at least a portion of the first image, the motion prediction circuitry 116 may use the image information and/or data from the first image to provide at least a portion of the image information and/or data representative of the prospective second image. In implementations where the prospective second image includes additional content beyond the extent or scope of the first scene, the motion prediction circuitry 116 determines, interpolates, extrapolates, or otherwise generates an estimate of one or more expected parameters (e.g., color, intensity, brightness, and similar) associated with the prospective second scene.

In some implementations, the exposure determination circuitry 112, the odometry sensor 114, and the motion prediction circuitry 116 may be disposed or otherwise formed or assembled on a common substrate, semiconductor package, or as a single device 110. In some implementations, the exposure determination circuitry 112, the odometry sensor 114, and/or the motion prediction circuitry 116 may be formed on separate substrates or disposed in a plurality of semiconductor packages.

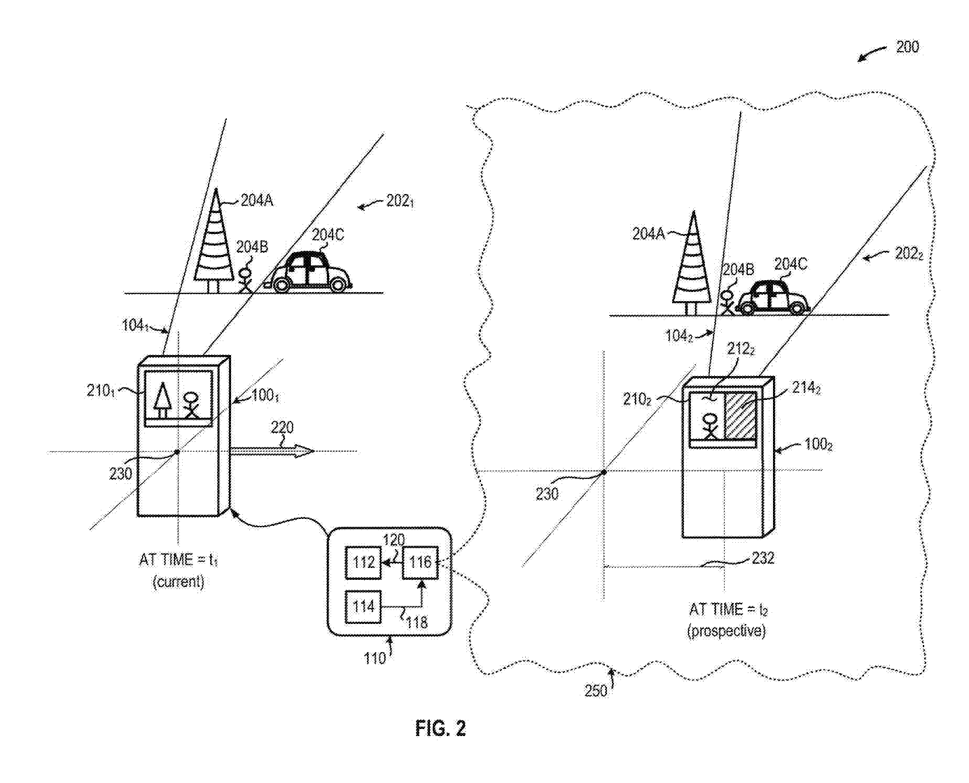

FIG. 2 depicts an illustrative system 200 in which a odometric image capture system 100 moved, displaced, or otherwise translated through a three-dimensional system acquires a first image 210₁ of a scene 202 at current time=t₁ and in which the motion prediction circuitry 116 determines a prospective second image 210₂ of the scene 202 at future time=t₂, in accordance with at least one embodiment described herein. At current time=t₁, the image acquisition device 106 covers a current field-of-view 1041 that includes a first scene 210₁. The first scene 210₁ contains a first object 204A and a second object 204B. A third object 204C is outside of the field-of-view 104 of the image acquisition device 106 and therefore does not appear in the first (i.e., the current) image 210₁ displayed on the odometric image capture system 100.

As depicted in FIG. 2, in embodiments, the odometric image capture system 100 may be moved, displaced, or otherwise translated in a linear, curvilinear, or curved trajectory 220 through the three-dimensional space. Such movement or translation may be intentional on the part of the system user (e.g., a system user attempting to follow or pan a moving object appearing in the field-of-view 104 of the image acquisition device 106); unintentional movement, motion, or shaking on the part of the system user (e.g., hand shake as the image acquisition device is activated); or a combination thereof. The odometric sensors 114 detect the movement of the system 100 and generate one or more odometric signals 118 that include data indicative of one or more of: the movement of the system 100, the displacement of the system 100, the acceleration of the system 100, the velocity of the system 100, the angular rotation of the system 100, the angular velocity of the system 100, the angular acceleration of the system 100, or combinations thereof.

In embodiments, the equation of motion may be expressed as:

\ddot{x}=a (1)
where: x=the three-dimensional position
   a=acceleration

$$\dot{R} = [ \begin{matrix}0 & {ω}_{z} & - {ω}_{y} \\ - {ω}_{z} & 0 & {ω}_{x} \\ {ω}_{y} & - {ω}_{x} & 0\end{matrix} ] R \qquad ( 2 )$$

where: R=Rotation matrix related to pose of the frame of reference
   ω=angular velocity

The motion prediction circuitry 116 receives the odometric signal 118 containing the odometric information and the image signal 126 from the image acquisition device 106. Using the received odometric data and the image data, the motion prediction circuitry 116 may determine a future location of the odometric image capture system 100 at future time=t₂, based on the distance 232 through which the odometric image capture system 100 will be displaced at future time=t₂.

In some embodiments, such as when the odometric image capture system 100 remains stationary, the field-of-view 104 of the image acquisition device 106 remains stationary and the prospective second image 210₂ is similar or even identical to the first image 210₁. In some embodiments, the motion prediction circuitry 116 may generate or otherwise determine a prospective field-of-view 104₂ in which a portion of the first scene 212₂ forms a first portion of the prospective second image 210₂ and a new scene 214₂ forms the remaining portion of the prospective second (i.e., future) image 210₂. For example, as depicted in FIG. 2, the field-of-view 104₂ at future time=t₂, may include an object 204B included in the first image 210₁ and a new object 204C. In some embodiments, the motion prediction circuitry 116 may generate or otherwise determine a prospective field-of-view 104₂ in which a new scene 214₂ forms the entirety of the prospective second image 210₂. The motion prediction circuitry 116 may determine one or more content parameters for each new scene 214₂ that forms a portion of the prospective second image 210₂. In embodiments, the motion prediction circuitry 116 may use one or more techniques, algorithms, or similar to determine and/or predict one or more content parameters of the new scene 214₂ portions of the prospective second image 210₂. Such parameters may include, but are not limited to, brightness, color, gamut, tone, and similar.

In embodiments, the camera matrix may be written as follows:

$$K = [ \begin{matrix}{f}_{x} & 0 & {p}_{x} \\ 0 & {f}_{y} & {p}_{y} \\ 0 & 0 & 1\end{matrix} ] \qquad ( 3 )$$

where: fₓ=focal length (x axis) of camera,
   f_{y}=focal length (y axis) of camera,
   pₓ=principal point (x axis) of camera,
   p_{y}=principal point (y axis) of camera.

Given the camera relative motion as R (see Eqn. 2, above), the rotation matrix and T the translation vector, the mapping between a point in the current image 210₁ to a point in the future image 210₂ is as follows:

Let:

$$[ \begin{matrix}X \\ Y\end{matrix} ] = [ \begin{matrix}\frac{x}{z} \\ \frac{y}{z}\end{matrix} ] \qquad ( 4 )$$

be a point in the first image 210₁ where x, y, and z are real-world coordinates. The coordinate transformation is then:

$$[ \begin{matrix}{x}^{′} \\ {y}^{′} \\ {z}^{′}\end{matrix} ] = K [ R [ \begin{matrix}x \\ y \\ z\end{matrix} ] + T ] \qquad ( 5 )$$

where:

$$[ \begin{matrix}{x}^{′} \\ {y}^{′} \\ {z}^{′}\end{matrix} ]$$

is mapped to the second camera image coordinates by

$$[ \begin{matrix}{X}^{′} \\ {Y}^{′}\end{matrix} ] = [ \begin{matrix}\frac{{x}^{′}}{{z}^{′}} \\ \frac{{y}^{′}}{{z}^{′}}\end{matrix} ] .$$

In some situations, the value for z may be unknown. Generally, it may be assumed:

z>>fₓ, f_{y}, Tₓ, T_{y}, T_{z} (6)

In general, fₓ and f_{y} are typically only a few millimeters and the translation motion between two image frames is few centimeters. When applied to the transformation in Eqn. (5) above, knowledge of z is not needed to obtain an accurate approximation. If it is assumed that the rotation of the image acquisition device 106 is small, the transformation in Eqn. (5) above may be approximated by:

$$[ \begin{matrix}{X}^{′} \\ {Y}^{′}\end{matrix} ] = [ \begin{matrix}cos {θ}_{z} & sin {θ}_{z} \\ - sin {θ}_{z} & cos {θ}_{z}\end{matrix} ] [ \begin{matrix}X \\ Y\end{matrix} ] + [ \begin{matrix}{f}_{x} {θ}_{x} \\ {f}_{y} {θ}_{y}\end{matrix} ] \qquad ( 7 )$$

where: θₓ=the rotation angle around the x-axis
θ_{y}=the rotation angle around the y-axis
θ_{z}=the rotation angle around the z-axis

The motion prediction circuitry 116 generates an output signal 120 that includes information and/or data associated with the prospective second image 210₂. The motion prediction circuitry 116 communicates the output signal 120 to the exposure determination circuitry 112. In at least some embodiments, the motion prediction circuitry 116 generates the output signal 120 at a rate exceeding the frame rate of the image acquisition device 106. For example, using an image acquisition device 106 having a 30 frame per second frame rate, the motion prediction circuitry 116 may generate the output signal 120 in less than 1/30 of a second.

The exposure determination circuitry 112 receives the output signal 120 from the motion prediction circuitry 116 and determines one or more prospective exposure parameters. The one or more prospective exposure parameters may include, but are not limited to, aperture, shutter speed, gain, sensitivity, or combinations thereof. In embodiments, the exposure determination circuitry 112 generates an output signal 124 that includes the one or more prospective exposure parameters. The exposure determination circuitry 112 communicates the output signal 124 to the image acquisition device 106. In at least some embodiments, the motion prediction circuitry 116 generates the output signal 120 and the exposure determination circuitry 112 determines the one or more exposure parameters for the prospective second image 210₂ at a rate exceeding the frame rate of the image acquisition device 106. For example, using an image acquisition device 106 having a 30 frame per second frame rate, the motion prediction circuitry 116 may generate the output signal 120 and the exposure determination circuitry 112 determines the one or more exposure parameters in less than 1/30 of a second.

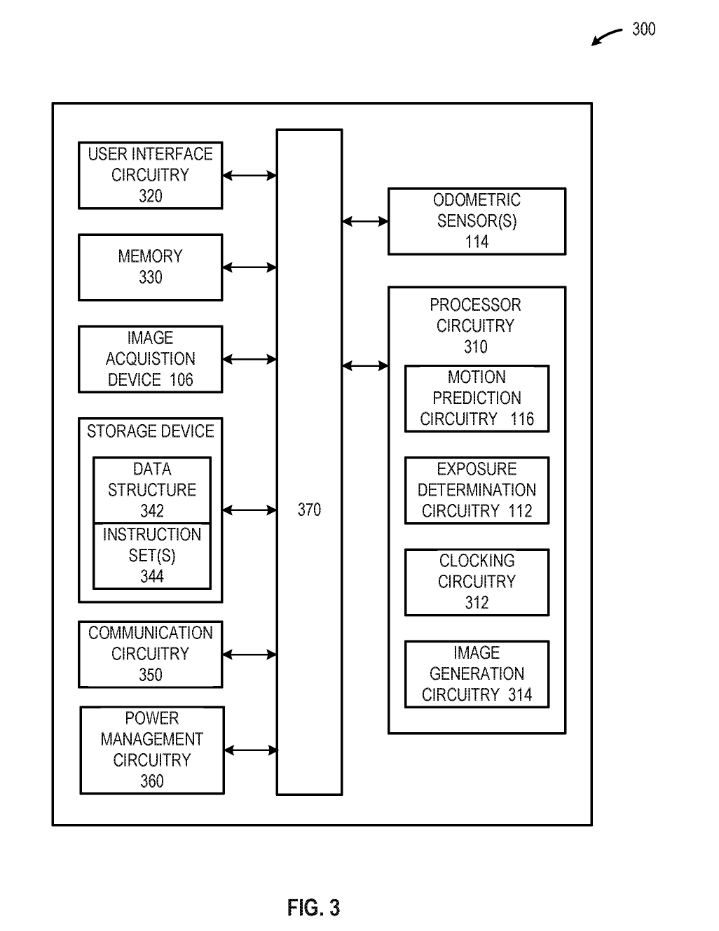

FIG. 3 depicts an illustrative processor-based apparatus or device 300 that includes a odometric image capture system 100, in accordance with at least one embodiment described herein. The device 300 may include some or all of: processor circuitry 310, user interface circuitry 320, a memory 330, non-transitory storage devices 340, communication circuitry 350, power management circuitry 360, and one or more buses or similar communications links 370 that communicably couples the various components in the device 300. Example devices 300 may include, but are not limited to, one or more portable processor-based devices such as still cameras, video cameras, smartphones, portable digital assistants, wearable devices, portable computers, handheld computers, and similar.

The device 300 includes an odometric image capture system 100 that includes one or more image acquisition devices 106 and one or odometric sensors 114. In some implementations, one or more single or multi-core processors, controllers, microprocessors, or microcontrollers may provide at least a portion of the odometric image capture system 100. For example, as depicted in FIG. 3, the processor circuitry 310 provides both the exposure determination circuitry 112 and/or the motion prediction circuitry 116.

The processor circuitry 310 may include one or more processors situated in separate components, or alternatively, may include one or more processing cores embodied in a single component (e.g., in a System-on-a-Chip (SoC) configuration) and any processor-related support circuitry (e.g., bridging interfaces, and similar). In embodiments, the processor circuitry 310 may include, but is not limited to, various x86-based microprocessors available from the Intel Corp. (SANTA CLARA, Calif.) including those in the Pentium®, Xeon®, Itanium®, Celeron®, Atom®, Core i-series product families, Advanced RISC (Reduced Instruction Set Computing) Machine or “ARM” processors, etc. The processor circuitry 310 may include support circuitry to facilitate communication between components. Examples of such support circuitry may include chipsets such as Northbridge and/or Southbridge chipsets configured to provide an interface through which processor circuitry 310 interacts, communicates, and/or exchanges data with other components that may be operating at different speeds, on different buses, etc. in device 300. Some or all of the functionality commonly associated with the support circuitry may also be included in the same physical package as a microprocessor (e.g., in an SoC package like the Sandy Bridge integrated circuit available from the Intel Corp.).

The processor circuitry 310 may include clocking circuitry 312 and/or image generation circuitry 314. Clocking circuitry 312 may be used to adjust the clock speed of the processor circuitry 310 such that the exposure determination circuitry 112 and the motion prediction circuitry 116 are able to provide exposure parameters to the image acquisition device(s) 106 at a rate that exceeds the frame capture rate of the image acquisition device(s) 106. Such would advantageously permit the prospective determination of exposure parameters 122 for each image acquired using the image acquisition device(s) 106, thereby reducing or even eliminating latency in the image acquisition system of device 300. The image generating circuitry 314 may receive image data from the image acquisition device(s) 106 and may generate or otherwise produce a display that provides a human perceptible output to the device user containing all or a portion of the image information and/or data provided by the image acquisition device(s) 106.

The processor circuitry 310 may execute various machine-readable instructions in the form of one or more instruction sets. The instruction sets may include program code and/or logic configured to cause at least a portion of the processing circuitry 310 to form and function as particular and specialized exposure determination circuitry 112 and/or particular and specialized motion prediction circuitry 116. The instruction sets may further include program code and/or logic configured to cause the processor circuitry 310 to perform activities related to reading data, writing data, processing data, formulating data, converting data, transforming data, etc. The instruction sets may be stored in, on, or about the storage device 340 in a non-transitory format. All or a portion of the instruction sets may be loaded from the storage device 340 into system memory 330 when executed by the processor circuitry 310.

The user interface circuitry 320 includes circuitry configured to allow device users to interact with device 300. The user interface circuitry may include one or more user input mechanisms (microphones, switches, buttons, knobs, keyboards, speakers, touch-sensitive surfaces, one or more sensors configured to capture images and/or sense proximity, distance, motion, gestures, etc.) and/or one or more output mechanisms (speakers, displays, lighted/flashing indicators, electromechanical components for vibration, motion, etc.).

The device memory 330 may include random access memory (RAM) and/or read-only memory (ROM) in a fixed or removable format. RAM may include memory configured to hold information during the operation of device 300 such as, for example, static RAM (SRAM) or Dynamic RAM (DRAM). ROM may include memories such as bios memory configured to provide instructions when device 300 activates in the form of basic input/output system (BIOS), Unified Extensible Firmware Interface (UEFI), etc., programmable memories such as electronic programmable ROMs (EPROMS), Flash, etc.

The storage device 340 may include any number and/or combination of fixed and/or removable storage devices. The storage device 340 may include one or more magnetic storage devices (e.g., rotating media such as a hard disk drive), one or more solid state storage devices (e.g., solid state drive, embedded multimedia card (eMMC), and similar), one or more removable memory cards or sticks (e.g., micro storage device (uSD), USB, or similar), one or more optical memories such as compact disc-based ROM (CD-ROM), or combinations thereof.

The storage device 340 may store or otherwise retain one or more data structures 342. Such data structures 342 may include, but are not limited to, one or more data structures that includes information

The storage device 340 may store or otherwise retain one or more program files and/or instruction sets 344. The one or more instruction sets 344 may include one or more algorithms used by the motion prediction circuitry 116 to determine the content and/or composition of a prospective second image 210₂. Such instruction sets 344 may use one or more extrapolative or interpolative algorithms to determine at least a portion of the content and/or composition of a prospective second image 210₂ thereby enabling the exposure determination circuitry 112 to determine one or more exposure parameters 124 for communication to the image acquisition device 106. In one embodiment, the instruction sets 344 may include one or more instruction sets used to determine the composition of the prospective second image 210₂ at a future time=t₂ using all or a portion of the data contained in the current image 210₁ obtained at time=t₁:

Iₛ(x, y)=I(Tₓ(x, y), T_{y}(x, y)) (8)

Where:
I, Iₛ are the current image 210₁ and the future image 210₂, respectively;
Tₓ, T_{y} are the pixel transformation induced by camera motion.

In another embodiment, the instruction sets 344 may include one or more instruction sets used to determine one or more exposure parameters for the prospective second image 210₂ at a future time=t2 using weighted values for each pixel in the prospective second image:

Wₛ(x, y)=W(Tₓ⁻¹(x, y), T_{y}⁻¹(x, y)) (9)

Where:
W, Wₛ are the weights and modified weights, respectively.

In another embodiment, the data structure 342 may be used to store content and/or exposure information for at least some prior to previous image acquisition device poses (i.e., device 300 location and/or orientation within the three-dimensional space). Such a data store may be used by the exposure determination circuitry 112 to look up historical exposure information used by the image acquisition device 106 once the prospective future pose information is received from the motion prediction circuitry 116. Such may advantageously permit a rapid determination of exposure parameters based on one or more actual exposure parameters used previously by the image acquisition device 106.

The communication circuitry 350 may include resources configured to support wired and/or wireless communication between the device 300 and one or more external devices, servers, routers, or similar components. Wired communications may include serial and parallel wired mediums such as, for example, Ethernet, Universal Serial Bus (USB), Firewire, Digital Visual Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g., Bluetooth, wireless local area networking (WLAN), Wi-Fi, and similar) and long range wireless mediums (e.g., cellular wide area radio communication technology, satellite technology, and similar).

The power management circuitry 360 may include one or more internal energy sources (e.g., a battery) and/or one or more external power sources (e.g., electromechanical or solar generator, power grid, fuel cell, and similar). The power management circuitry 360 may be configured to supply, distribute, and/or regulate power flow to the various devices, sub-systems, and components included in the device 300.

The bus 370 may include one or more conductive pathways linking or otherwise communicably interconnecting or coupling some or all of the components coupled to the device 300. The bus 370 may include one or more serial or parallel buses having any bus width (e.g., 8-bit, 16-bit, 64-bit, 128-bit, 256-bit).

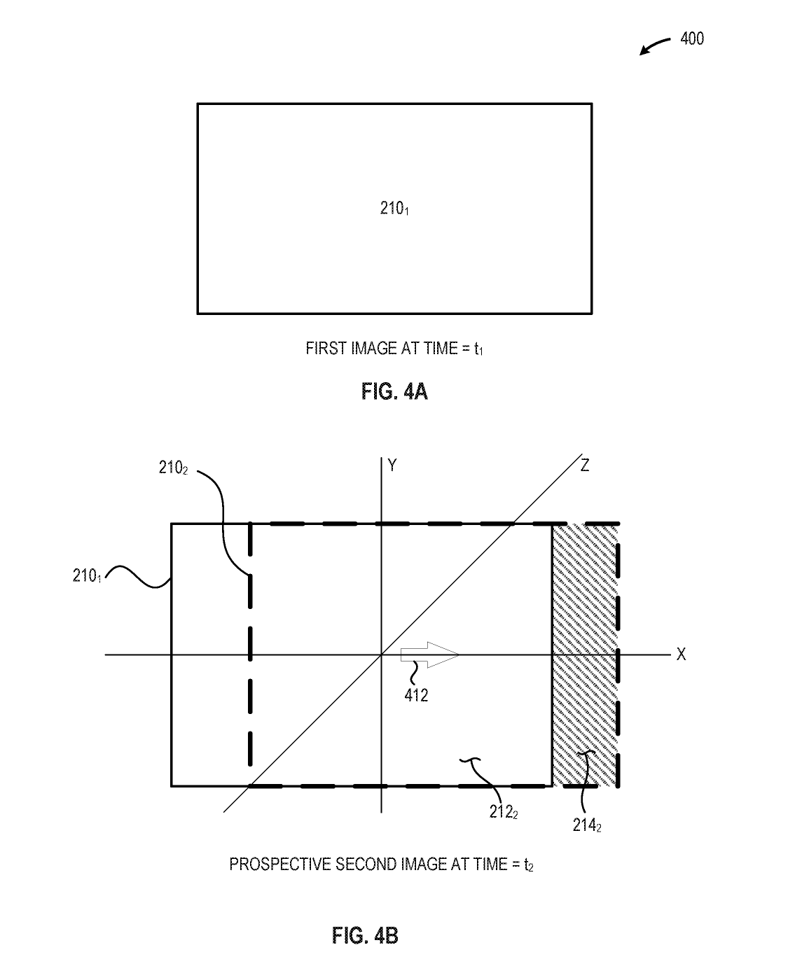

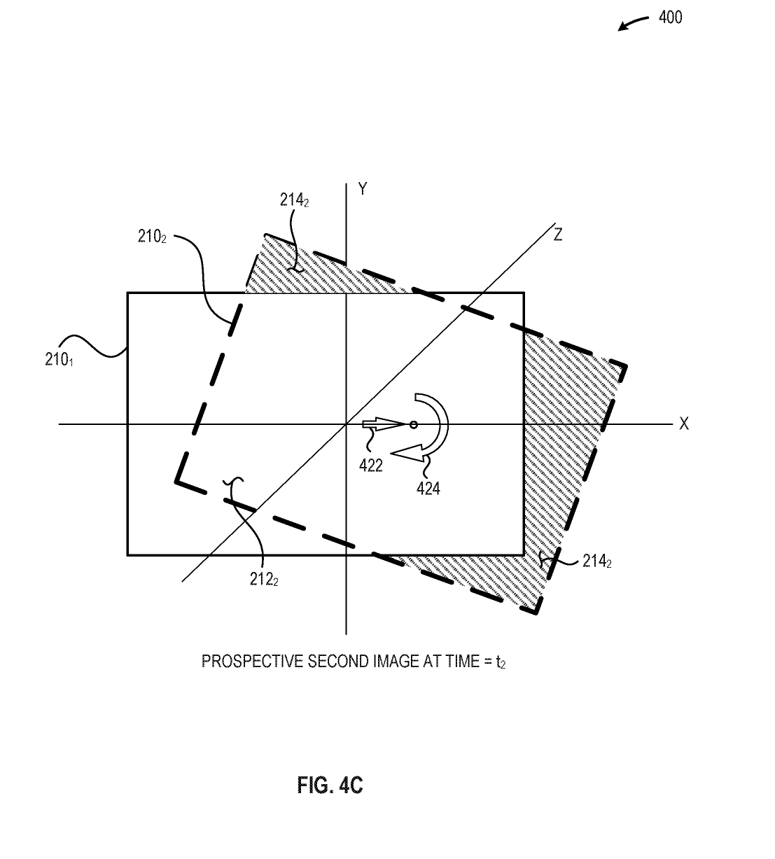

FIG. 4A depicts an illustrative current first image 210₁ acquired by a odometric image capture system 100 at a current first time=t₁, in accordance with at least one embodiment described herein. FIG. 4B depicts an illustrative prospective or future second image 210₂ acquired by the odometric image capture system 100 at a future second time=t₂ overlaid on the illustrative current first image 210₁ depicted in FIG. 4A, in accordance with at least one embodiment described herein. FIG. 4C depicts another illustrative prospective or future second image 210₂ acquired by the odometric image capture system 100 at a future second time=t₂ overlaid on the illustrative current first image 210₁ depicted in FIG. 4A, in accordance with at least one embodiment described herein.

As depicted in FIG. 4B, the prospective second image 210₂ is linearly displaced 412 from the current first image 210₁, such a displacement may correspond to or otherwise correlate with a linear movement of the odometric image capture system 100 as sensed by the odometric sensors 114. The prospective second image 210₂ includes a first portion 212₂ that includes part of the current first image 210₁ and a second portion 214₂ that includes a new scene that is not visible in the current first image 210₁. The odometric image capture system 100 generates information and/or data associated with the second portion 214₂ of the prospective second image 210₂. The exposure determination circuitry 112 may use exposure data associated with the current first image 210₁ along with the generated information and/or data associated with the second portion 214₂ to determine one or more exposure parameters for the prospective second image 210₂.

As depicted in FIG. 4C, the prospective second image 210₂ is both linearly displaced 422 and rotationally displaced 424 from the current first image 210₁, such a displacement may correspond to or otherwise correlate with a linear and rotational movement of the odometric image capture system 100 as sensed by the odometric sensors 114. The prospective second image 210₂ includes a first portion 212₂ that includes part of the current first image 210₁ and a two-part second portion 214₂ that includes a new scene that is not visible in the current first image 210₁. The odometric image capture system 100 generates information and/or data associated with both parts of the second portion 214₂ of the prospective second image 210₂. The exposure determination circuitry 112 may use exposure data associated with the current first image 210₁ along with the generated information and/or data associated with both parts of the second portion 214₂ to determine one or more exposure parameters for the prospective second image 210_{2.}

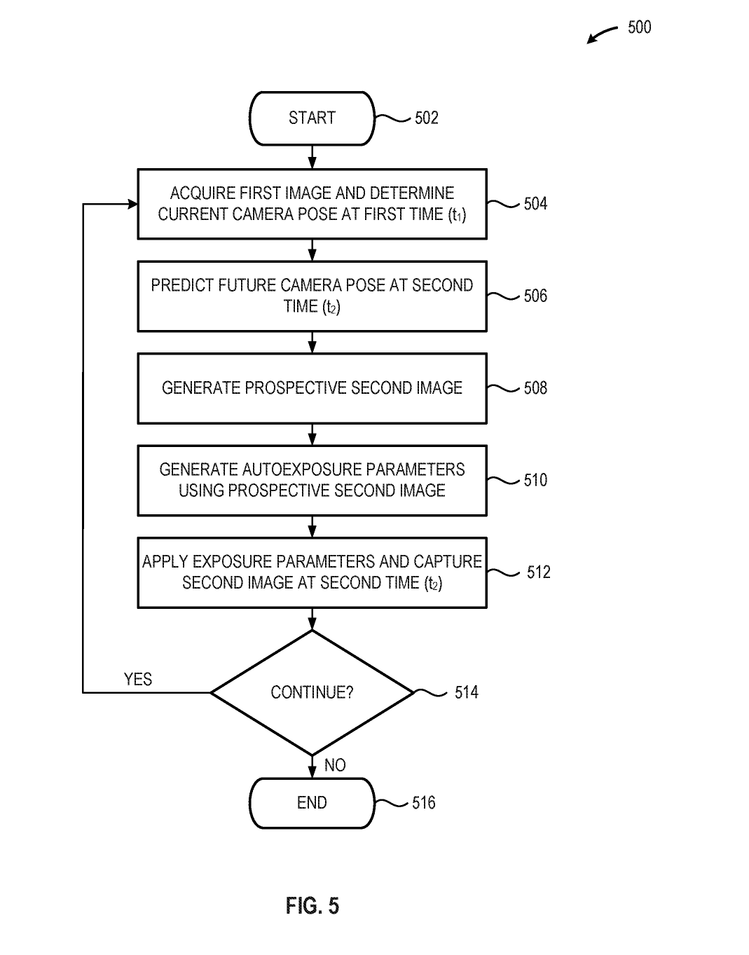

FIG. 5 depicts a logic flow diagram of an illustrative odometric image capture method 500, in accordance with at least one embodiment described herein. Using the current location and pose of the odometric image capture system 100 at a current first time=t₁, the sensed odometric, or motion, data collected may be used to determine the location and pose of the odometric image capture system 100 at a future second time=t₂. With knowledge of the field-of-view 104 of the odometric image capture system 100, a prospective second image 210₂ at future time=t₂ may be generated by combining all or a portion of the current image 210₁ with generated “fill in” data in new parts of the prospective second image 210₂ that fall outside of the current field-of-view 104 of the odometric image capture system 100. The prospective second image 210₂ may then be used to generate one or more exposure parameters that may be applied to the image acquisition device 106 prior to time=t₂. The method 500 commences at 502.

At 504, the image acquisition device 106 acquires a current first image 210₁ at time=t₁. Additionally, the odometric image capture system 100 may also determine the first location and/or pose of the odometric image capture system 100 using information and/or data provided in one or more signals 118 provided by one or more odometric sensors 114. In at least some implementations, the odometric image capture system 100 continuously determines at least one of the location and/or pose of the odometric image capture system 100. In some embodiments, the odometric image capture system 100 intermittently, periodically, or aperiodically determines at least one of the location and/or pose of the odometric image capture system 100. The odometric sensors 106 communicate one or more odometric signals 118 that carry the position, motion, and/or location information to the motion prediction circuitry 116.

At 506, the motion prediction circuitry 116 predicts a future location and/or pose of the odometric image capture system 100 at a future time=t₂. To predict the future location and/or pose of the odometric image capture system 100, the motion prediction circuitry 116 receives information and/or data associated with the current first image 210₁ from the image acquisition device 106 and one or more odometric signals 118 from the one or more odometric sensors 114. The motion prediction circuitry 116 may employ any number and or combination of algorithms, systems, and/or methods to determine or otherwise forecast the future location and/or pose of the odometric image capture system 100.

At 508, the odometric image capture system 100 generates a prospective second image 210₂ based on the future location of the odometric image capture system 100 and the expected field-of-view 104₂ at a future time=t₂. In some implementations, the prospective second image 210₂ includes sufficient information regarding ambient conditions to permit the exposure determination circuitry 112 to determine one or more appropriate exposure parameters for the image acquisition device 106 to acquire the prospective second image at future time=t₂. In some implementations, the prospective second image 210₂ may include image data acquired from the current first image 210₁ (i.e., to the extent that the prospective second image 210₂ and the current first image 210₁ overlap). In some implementations, the prospective second image 210₂ may include information and/or data generated or otherwise acquired by the motion prediction circuitry 116. For example, the prospective second image 210₂ may include ambient illumination information and/or data provided by one or more ambient illumination sensors or similar.

At 510, the exposure determination circuitry 112 generates one or more auto-exposure parameters using the prospective second image 210₂. The exposure determination circuitry 112 may employ any number and/or combination of methods and/or algorithms to determine the one or more auto-exposure parameters.

At 512, the exposure determination circuitry 112 communicates the generated auto-exposure parameters 124 to the image acquisition device 106. In embodiments, the exposure determination circuitry 112 communicates the auto-exposure parameters to the image acquisition device 106 prior to the future time=t₂ such that the auto-exposure parameters may be used by the image acquisition device 106 to acquire an image at time=t₂.

At 514, the odometric image capture system 100 determines whether the odometric image capture system 100 will acquire images on an ongoing basis (e.g., frames of a video recording). If additional future images will be acquired, the method 500 returns to 504. If no additional future images will be acquired, the method 500 concludes at 516.

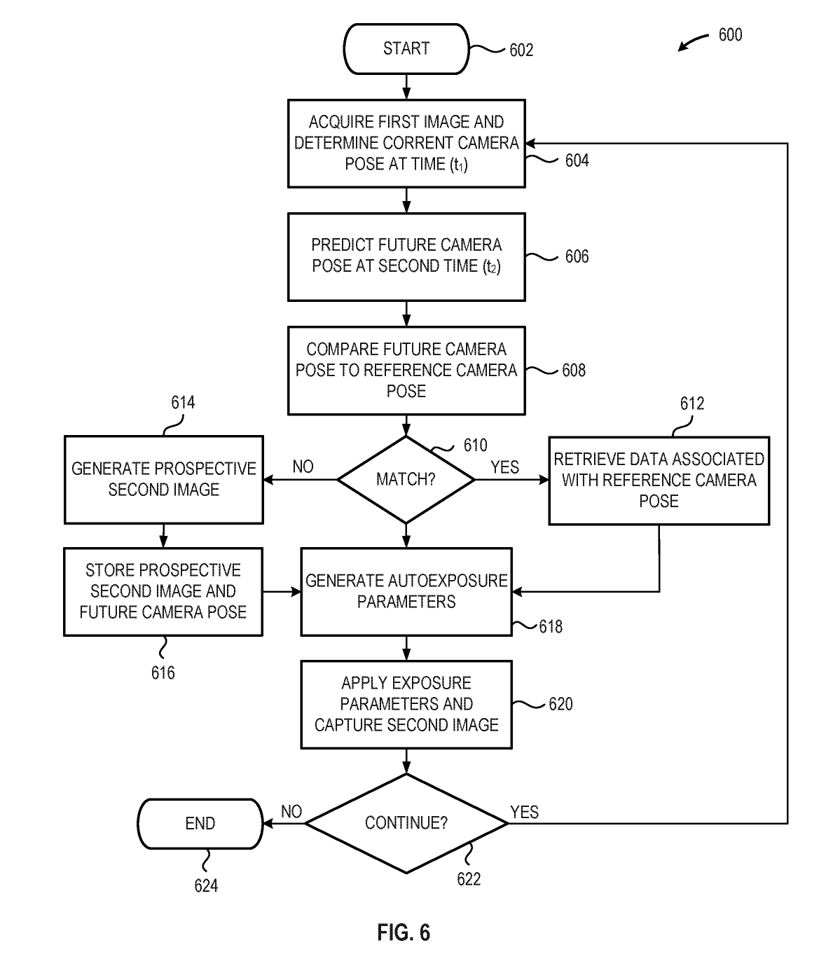

FIG. 6 depicts a logic flow diagram of an illustrative odometric image capture method 600, in accordance with at least one embodiment described herein. Using the current location and pose of the odometric image capture system 100 at a current first time=t₁, the sensed odometric, or motion, data collected may be used to determine the location and pose of the odometric image capture system 100 at a future second time=t₂. If exposure information associated with the location and pose of the odometric image capture system 100 at future time=t₂ is available, the odometric image capture system 100 may use the historical exposure information to acquire the second image at future time=t₂. If historical exposure information is not available, with knowledge of the field-of-view 104 of the odometric image capture system 100, a prospective second image 210₂ at future time=t₂ may be generated by combining all or a portion of the current image 210₁ with generated “fill in” data in new parts of the prospective second image 210₂ that fall outside of the current field-of-view 104 of the odometric image capture system 100. The prospective second image 210₂ may then be used to generate one or more exposure parameters that may be applied to the image acquisition device 106 prior to time=t₂. The method 600 commences at 602.

At 604, the image acquisition device 106 acquires a current first image 210₁ at time=t₁. Additionally, the odometric image capture system 100 may also determine the first location and/or pose of the odometric image capture system 100 using information and/or data provided in one or more signals 118 provided by one or more odometric sensors 114. In at least some implementations, the odometric image capture system 100 continuously determines at least one of the location and/or pose of the odometric image capture system 100. In some embodiments, the odometric image capture system 100 intermittently, periodically, or aperiodically determines at least one of the location and/or pose of the odometric image capture system 100. The odometric sensors 106 communicate one or more odometric signals 118 that carry the position, motion, and/or location information to the motion prediction circuitry 116.

At 606, the motion prediction circuitry 116 predicts a future location and/or pose of the odometric image capture system 100 at a future time=t₂. To predict the future location and/or pose of the odometric image capture system 100, the motion prediction circuitry 116 receives information and/or data associated with the current first image 210₁ from the image acquisition device 106 and one or more odometric signals 118 from the one or more odometric sensors 114. The motion prediction circuitry 116 may employ any number and or combination of algorithms, systems, and/or methods to determine or otherwise forecast the future location and/or pose of the odometric image capture system 100.

At 608, the motion prediction circuitry 116 compares the projected location and/or pose of the odometric image capture system 100 at future time=t₂ with locations and/or poses included in a data structure 342 containing historical location and/or pose information and corresponding auto-exposure parameters 124. The availability of historical auto-exposure parameters corresponding to odometric image capture system 100 locations and/or poses beneficially reduces the time needed to determine auto-exposure parameters 124 for transmission to the image acquisition device 106, particularly when compared to the time needed to generate content information associated with the prospective second image and determine one or more auto-exposure parameters based on the generated content information.

At 610, the motion prediction circuitry 116 determines whether the projected location and/or pose of the odometric image capture system 100 at future time=t₂ matches a historical location and/or pose included in a data store. If the motion prediction circuitry 116 determines a historical location and/or pose included in the data structure 342 matches the projected location and/or pose of the odometric image capture system 100 at future time=t₂, the method 600 continues at 612. If the motion prediction circuitry 116 determines a historical location and/or pose in the data structure 342 does not match the projected location and/or pose of the odometric image capture system 100 at future time=t₂, the method 600 continues at 614.

At 612, responsive to determining a historical location and/or pose included in the data structure 342 matches the projected location and/or pose of the odometric image capture system 100 at future time=t₂, the motion prediction circuitry 116 retrieves the auto-exposure parameters associated with the historical location from the data structure 342.

At 614, responsive to determining the historical location and/or pose included in the data structure 342 does not match the projected location and/or pose of the odometric image capture system 100 at future time=t₂, the odometric image capture system 100 generates a prospective second image 210₂ based on the future location of the odometric image capture system 100 and the expected field-of-view 104₂ at a future time=t₂. The prospective second image 210₂ includes information regarding ambient conditions sufficient to permit the exposure determination circuitry 112 to determine one or more appropriate auto-exposure parameters 124 for the prospective second image 210₂ at future time=t₂. In some implementations, the prospective second image 210₂ may include image data acquired from the current first image 210₁ (i.e., to the extent that the prospective second image 210₂ and the current first image 210₁ overlap). In some implementations, the prospective second image 210₂ may include information and/or data generated or otherwise acquired by the motion prediction circuitry 116. For example, the prospective second image 210₂ may include ambient illumination information and/or data provided to the motion prediction circuitry 116 by one or more ambient illumination sensors or similar.

At 616, the motion prediction circuitry 116 stores the information and/or data representative of the prospective second image 210₂ and the future location and/or pose of the odometric image capture system 100 at future time=t₂ in the data structure.

At 618, the exposure determination circuitry 112 generates one or more auto-exposure parameters using the prospective second image 210₂. The exposure determination circuitry 112 may employ any number and/or combination of methods and/or algorithms to determine the one or more auto-exposure parameters. Where the historical location and/or pose included in the data structure 342 does not match the projected location and/or pose of the odometric image capture system 100 at future time=t₂, the exposure determination circuitry 112 may store at least a portion of the generated auto-exposure parameters in the data structure 342.

At 620, the exposure determination circuitry 112 communicates the generated auto-exposure parameters 124 to the image acquisition device 106. In embodiments, the exposure determination circuitry 112 communicates the auto-exposure parameters to the image acquisition device 106 prior to the future time=t₂ such that the auto-exposure parameters may be used by the image acquisition device 106 to acquire an image at time=t₂.

At 622, the odometric image capture system 100 determines whether the odometric image capture system 100 will acquire images on an ongoing basis (e.g., frames of a video recording). If additional future images will be acquired, the method 600 returns to 604. If no additional future images will be acquired, the method 600 concludes at 624.

While FIGS. 5 and 6 illustrate operations according to one or more embodiments, it is to be understood that not all of the operations depicted in FIGS. 5 and 6 are necessary for other embodiments. Indeed, it is fully contemplated herein that in other embodiments of the present disclosure, the operations depicted in FIGS. 5 and 6, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to an odometric image capture system capable of using the location and/or pose of the odometric image capture system and a current first image acquired by the odometric image capture system at the current time=t₁ to determine one or more auto-exposure parameters for an image acquired at a future time=t₂. Such systems may determine auto-exposure parameters for a future scene prior to future time=t₂ based on the movement of the odometric image capture system in a three-dimensional environment. Such predictive auto-exposure capabilities beneficially reduce the latency compared to systems that must first acquire the future scene at time=t₂ prior to determining one or more auto-exposure parameters. In embodiments, the odometric image capture system may include one or more data structures that include historical auto-exposure information and/or data based at least in part on historical odometric image capture system location and/or pose information.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for generating immersive audio utilizing visual cues.

According to example 1, there is provided a system for generating odometric auto-exposure information. The system may include: an image acquisition device; one or more odometric sensors to provide odometric data; processor circuitry communicably coupled to the image acquisition device and to the one or more odometric sensors. The processor circuitry may include: motion prediction circuitry; and exposure determination circuitry. The system may additionally include: a storage device that includes one or more instruction sets that, when executed by the processor circuitry cause the processor circuitry to, at a first time (t₁), cause the image acquisition device to acquire data representative of a first image within a field-of-view of the image acquisition device; cause the motion prediction circuitry to generate data indicative of a first pose of the image acquisition device in a three-dimensional space; cause the motion prediction circuitry to acquire odometric data indicative of a displacement of the image acquisition device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image; and, at the second time t₂, cause the image acquisition device to acquire data representative of a second image using the at least one determined auto-exposure parameter.

Example 2 may include elements of example 1 where the image acquisition device comprises an image acquisition device having a frame rate and where the frame rate of the image acquisition device is approximately equal to the interval between the first time and the second time.

Example 3 may include elements of example 1 where the motion prediction circuitry determines the predicted second pose of the image capture device at the second time (t₂) based on the acquired odometric data and the first pose of the image capture device.

Example 4 may include elements of example 1 where the processor circuitry generates the data representative of the prospective second image within the second field of view based on the predicted second pose of the image capture device and the data representative of the first image.

Example 5 may include elements of example 1 where one or more odometric sensors comprises one or more motion sensors.

Example 6 may include elements of example 1 where the processor circuitry determines whether the image acquisition device is stationary by comparing the received data indicative of a first pose of the image acquisition device with the generated data indicative of a predicted second pose of the image acquisition device.

Example 7 may include elements of example 6 and the system may additionally include a storage device having one or more data structures that include auto-exposure parameters associated with the first pose of the image acquisition device.

Example 8 may include elements of example 7 where the exposure determination circuitry retrieves the at least one auto-exposure parameter from the data structure based on the first pose of the image acquisition device.

Example 9 may include elements of example 1 where the second field of view and the first field of view at least partially overlap to provide an overlapped image portion that includes data representative of an image common to the first image and the prospective second image; and at least one non-overlapped image portion including data representative of only the prospective second image.

Example 10 may include elements of example 9 where the exposure determination circuitry generates data representative of at least one content parameter associated with prospective second image content in the at least one non-overlapped image portion.

Example 11 may include elements of example 10 where the exposure determination circuitry generates data representative of at least one content parameter associated with prospective second image content in the at least one non-overlapped image portion by extrapolating the at least one content parameter for the prospective second image content in the at least one non-overlapped image portion using the acquired first image.

Example 12 may include elements of example 10 and the system may additionally include at least one ambient sensor communicably coupled to the exposure determination circuitry, the at least one ambient sensor to generate data indicative of at least one ambient condition.

Example 13 may include elements of example 12 where the at least one ambient sensor generates an output signal that includes data indicative of an ambient illumination level; and where the exposure determination circuitry determines the at least one auto-exposure parameter using the data indicative of the ambient illumination level.

According to example 14, there is provided an odometric auto-exposure controller. The controller may include processor circuitry to, at a first time (t₁), cause a communicably coupled image acquisition device to acquire data representative of a first image within a field-of-view of the image acquisition device; cause motion prediction circuitry to generate data indicative of a first pose of the image acquisition device in a three-dimensional space; cause the motion prediction circuitry to acquire odometric data indicative of a displacement of the image capture device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image, and at the second time t₂, cause the image acquisition device to acquire data representative of a second image using the at least one determined auto-exposure parameter.

Example 15 may include elements of example 14 where the communicably coupled image acquisition device comprises a communicably coupled image acquisition device having a frame rate and where the frame rate of the communicably coupled image acquisition device is approximately equal to the interval between the first time and the second time.

Example 16 may include elements of example 14 where the processor circuitry causes the motion prediction circuitry to generate the data indicative of the predicted second pose of the image capture device in the three-dimensional space at the second time (t₂) using at least: the acquired odometric data; and the first pose of the image capture device.

Example 17 may include elements of example 14 where the processor circuitry further generates the data representative of the prospective second image within the second field of view based on the predicted second pose of the image capture device and the data representative of the first image.

Example 18 may include elements of example 14 where the processor circuitry further determines whether the image acquisition device is stationary by comparing the received data indicative of a first pose of the image acquisition device with the generated data indicative of a predicted second pose of the image acquisition device.

Example 19 may include elements of example 18 where the exposure determination circuitry retrieves the at least one auto-exposure parameter from a communicably coupled storage device having one or more data structures that include auto-exposure parameters associated with the first pose of the image acquisition device.

Example 20 may include elements of example 14 where the second field of view and the first field of view at least partially overlap to provide: an overlapped image portion that includes data representative of an image common to the first image and the prospective second image; and at least one non-overlapped image portion including data representative of only the prospective second image.

Example 21 may include elements of example 20 where the processor circuitry causes the exposure determination circuitry to generate data representative of at least one content parameter associated with prospective second image content in the at least one non-overlapped image portion.

Example 22 may include elements of example 21 where the processor circuitry causes the exposure determination circuitry to generate data representative of at least one content parameter associated with prospective second image content in the at least one non-overlapped image portion by extrapolating the at least one content parameter for the prospective second image content in the at least one non-overlapped image portion using the acquired first image.

Example 23 may include elements of example 21 and the controller may additionally include at least one ambient sensor communicably coupled to the exposure determination circuitry, the at least one ambient sensor to generate data indicative of at least one ambient condition external to the system.

Example 24 may include elements of example 23 where the processor circuitry causes the exposure determination circuitry to receive from at least one ambient sensor an output signal that includes data indicative of an ambient illumination level and where the processor circuitry causes the exposure determination circuitry to determine at least one auto-exposure parameter using the received data indicative of the ambient illumination level.

According to example 25, there is provided an odometric auto-exposure method. The method may include: acquiring, at a first time (t₁), data representative of a first image in a first field-of-view of an image acquisition device; generating, at t₁, data indicative of a first pose of the image capture device in a three-dimensional space; acquiring, at t₁, odometric data indicative of a displacement of the image capture device in the three dimensional space; generating data indicative of a predicted second pose of the image acquisition device in the three-dimensional space at a second time (t₂); generating data representative of a prospective second image within a second field-of-view using the data representative of the predicted second pose of the image capture device; determining at least one auto-exposure parameter using the generated data representative of the prospective second image; and acquiring, at t₂, data representative of a second image using the image capture device and the one or more determined auto-exposure parameters.

Example 26 may include elements of example 25 where acquiring, at a first time (t₁), data representative of a first image and acquiring, at t₂, data representative of a second image may include acquiring data representative of a first image at t₁ acquiring data representative of a second image at t₂ where the difference between t₁ and t₂ is less than a frame rate of the image acquisition device.

Example 27 may include elements of example 25 where generating data indicative of a predicted second pose of the image acquisition device in the three-dimensional space at a second time (t₂) may include generating data indicative of the predicted second pose of the image acquisition device in the three-dimensional space at the second time (t₂) using at least the acquired odometric data and the first pose of the image acquisition device.

Example 28 may include elements of example 25 where generating data representative of a prospective second image within a second field-of-view using the data representative of the predicted second pose of the image acquisition device may include generating data representative of a prospective second image within a second field-of-view using the data representative of the predicted second pose of the image acquisition device and the data representative of the first image.

Example 29 may include elements of example 25, and the method may additionally include determining whether the image acquisition device is stationary by comparing the received data indicative of a first pose of the image acquisition device with the generated data indicative of a predicted second pose of the image acquisition device.

Example 30 may include elements of example 29 where determining at least one auto-exposure parameter using the generated data representative of the prospective second image may include retrieving the at least one auto-exposure parameter based on the first pose of the image acquisition device responsive to a determination that the image acquisition device is stationary.

Example 31 may include elements of example 25 and the method may additionally include, responsive to a determination that the image acquisition device is not stationary, determining an overlapped image portion that includes data representative of an image common to the first image and the prospective second image; and determining at least one non-overlapped image portion including data representative of only the prospective second image.

Example 32 may include elements of example 31 where determining at least one auto-exposure parameter using the generated data representative of the prospective second image may include generating data representative of the at least one content parameter associated with prospective second image content in the at least one non-overlapped image portion.

Example 33 may include elements of example 32 where generating data representative of the at least one content parameter associated with prospective second image content in the at least one non-overlapped image portion may include generating data representative of at least one content parameter associated with prospective second image content in the at least one non-overlapped image portion by extrapolating the at least one content parameter for the prospective second image content in the at least one non-overlapped image portion using the acquired first image.

Example 34 may include elements of example 32, and the method may additionally include generating data indicative of at least one ambient condition using at least one ambient sensor communicably coupled to the exposure determination circuitry.

Example 35 may include elements of example 34 where generating data indicative of at least one ambient condition using at least one ambient sensor communicably coupled to the exposure determination circuitry comprises receiving data indicative of an ambient illumination level from a communicably coupled ambient sensor and where determining at least one auto-exposure parameter comprises determining at least one auto-exposure parameter using the received data indicative of the ambient illumination level.

According to example 36, there is provided a non-transitory computer readable medium that includes one or more instruction sets that when executed by processor circuitry cause the processor circuitry to, at a first time (t₁), cause a communicably coupled image acquisition device to acquire data representative of a first image within a field-of-view of the image acquisition device; cause motion prediction circuitry to generate data indicative of a first pose of the image acquisition device in a three-dimensional space; cause the motion prediction circuitry to acquire odometric data indicative of a displacement of the image capture device in the three dimensional space; cause the motion prediction circuitry to generate data indicative of a predicted second pose of the image acquisition device in the three-dimensional space at a second time (t₂); generate data representative of a prospective second image within a second field of view using the data representative of the predicted second pose of the image acquisition device; and cause the exposure determination circuitry to determine at least one auto-exposure parameter using the generated data representative of the prospective second image; and at the second time t₂: cause the image acquisition device to acquire data representative of a second image using the at least one determined auto-exposure parameter.

Example 37 may include elements of example 36 where the instructions that cause the image acquisition device to acquire, data representative of a first image at t₁ and cause the image acquisition device to acquire data representative of a second image at t₂ may further cause the image acquisition device to acquire data representative of a first image at t₁ and acquire data representative of a second image at t₂, where the difference between t₁ and t₂ is less than a frame rate of the image acquisition device.

Example 38 may include elements of example 36 where the instructions that cause the processor circuitry to cause the motion prediction circuitry to generate data indicative of a predicted second pose of the image acquisition device in the three-dimensional space at a second time (t₂) may further cause the processor circuitry to cause the motion prediction circuitry to generate data indicative of a predicted second pose of the image acquisition device in the three-dimensional space at a second time (t₂) using the acquired odometric data and the first pose of the image capture device.

Example 39 may include elements of example 36 where the instructions that cause the processor circuitry to generate data representative of a prospective second image within a second field of view using the data representative of the predicted second pose of the image acquisition device may further cause the processor circuitry to: generate data representative of a prospective second image within a second field of view using the data representative of the predicted second pose of the image acquisition device and the data representative of the first image.

Example 40 may include elements of example 36 where the instructions may further cause the processor circuitry to determine whether the image acquisition device is stationary by comparing the received data indicative of a first pose of the image acquisition device with the generated data indicative of a predicted second pose of the image acquisition device.

Example 41 may include elements of example 36 where the instructions that cause the exposure determination circuitry to determine at least one auto-exposure parameter using the generated data representative of the prospective second image may further cause the exposure determination circuitry to retrieve the at least one auto-exposure parameter from a communicably coupled storage device having one or more data structures that include at least one auto-exposure parameter associated with the first pose of the image acquisition device.

Example 42 may include elements of example 36 where the first field-of-view and the second field-of-view at least partially overlap and the instructions may further cause the processor circuitry to identify an overlapped image portion that includes data representative of an image common to the first image and the prospective second image and identify at least one non-overlapped image portion including data representative of only the prospective second image.

Example 43 may include elements of example 42 where the instructions that cause the exposure determination circuitry to determine at least one auto-exposure parameter using the generated data representative of the prospective second image may further cause the exposure determination circuitry to generate data representative of at least one content parameter associated with prospective second image content in the at least one non-overlapped image portion.

Example 44 may include elements of example 43 where the instructions that cause the exposure determination circuitry to generate data representative of at least one content parameter associated with prospective second image content in the at least one non-overlapped image portion may further cause the exposure determination circuitry to generate data representative of at least one content parameter associated with prospective second image content in the at least one non-overlapped image portion by extrapolating the at least one content parameter for the prospective second image content in the at least one non-overlapped image portion using the acquired first image.

Example 45 may include elements of example 43 where wherein the instructions that cause the exposure determination circuitry to generate data representative of at least one content parameter associated with prospective second image content in the at least one non-overlapped image portion may further cause the exposure determination circuitry to receive, from at least one ambient sensor communicably coupled to the exposure determination circuitry, a signal including data indicative of at least one ambient condition.

Example 46 may include elements of example 45 where the instructions that cause the exposure determination circuitry determine at least one auto-exposure parameter, may further cause the exposure determination circuitry to receive, from the at least one ambient sensor, a signal that includes data representative of an ambient illumination level and determine at least one auto-exposure parameter using the received data indicative of the ambient illumination level.

According to example 47, there is provided an odometric auto-exposure system. The system may include: a means for acquiring data representative of a first image within a field-of-view of an image acquisition device at a first time (t₁); a means for generating data indicative of a first pose of the image acquisition device in a three-dimensional space at the first time; a means for acquiring odometric data indicative of a displacement of the image capture device in the three dimensional space; a means for generating data indicative of a predicted second pose of the image acquisition device in the three-dimensional space at a second time (t₂); a means for generating data representative of a prospective second image within a second field of view of the image acquisition device using the data representative of the predicted second pose of the image acquisition device; a means for determining at least one auto-exposure parameter using the generated data representative of the prospective second image; and a means for acquiring, at t₂, data representative of a second image using the at least one determined auto-exposure parameter.

Example 48 may include elements of example 47 where the means for acquiring the first image at t₁ and the means for acquiring the second image at t₂ may include a means for acquiring the first image at t₁ and the second image at t₂ where the difference between t₁ and t₂ is equal to or less than a frame rate of the means for acquiring the first image and the second image.

Example 49 may include elements of example 47 where the means for generating data indicative of a predicted second pose of the image acquisition device in the three-dimensional space at t₂ may further comprise a means for generating data indicative of a predicted second pose of the image acquisition device in the three-dimensional space at a second time (t₂) using the acquired odometric data and the first pose of the image capture device.

Example 50 may include elements of example 47 where the means for generating data representative of a prospective second image within a second field of view using the data representative of the predicted second pose of the image acquisition device may further comprise a means for generating data representative of a prospective second image within a second field of view using the data representative of the predicted second pose of the image acquisition device and the data representative of the first image.

Example 51 may include elements of example 47, and the system may further include a means for determining whether the image acquisition device is stationary by comparing the received data indicative of a first pose of the image acquisition device with the generated data indicative of a predicted second pose of the image acquisition device.

Example 52 may include elements of example 47 where the means for determining at least one auto-exposure parameter using the generated data representative of the prospective second image may further comprise a means for retrieving the at least one auto-exposure parameter from one or more data structures that include data representative of at least one auto-exposure parameter associated with the first pose of the image acquisition device.

Example 53 may include elements of example 47, and the system may additionally include a means for identifying an overlapped image portion that includes data representative of an image common to the first image and the prospective second image; and a means for identifying at least one non-overlapped image portion including data representative of only the prospective second image.

Example 54 may include elements of example 53 where the means for determining at least one auto-exposure parameter using the generated data representative of the prospective second image may further include a means for generating data representative of at least one content parameter associated with prospective second image content in the at least one non-overlapped image portion.

Example 55 may include elements of example 54 where the means for generating data representative of at least one content parameter associated with prospective second image content in the at least one non-overlapped image portion may further include a means for generating data representative of at least one content parameter associated with prospective second image content in the at least one non-overlapped image portion by extrapolating the at least one content parameter for the prospective second image content in the at least one non-overlapped image portion using the acquired first image.

Example 56 may include elements of example 54 where the means for generating data representative of at least one content parameter associated with prospective second image content in the at least one non-overlapped image portion may further include a means for receiving a signal that includes data indicative of at least one ambient condition.

Example 57 may include elements of example 56 where the means for receiving a signal that includes data indicative of at least one ambient condition may include a means for receiving a signal that includes data indicative of an ambient illumination level and where the means for determining at least one auto-exposure parameter may further comprises a means for determining the at least one auto-exposure parameter using the data indicative of the ambient illumination level.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A system for generating auto-exposure information, the system comprising:
an image acquisition device;
one or more sensors to provide motion data;
processor circuitry communicably coupled to the image acquisition device and to the one or more sensors, the processor circuitry including:
motion prediction circuitry; and
exposure determination circuitry;
a storage device that includes one or more instruction sets that, when executed by the processor circuitry cause the processor circuitry to:
at a first time (t₁):
cause the image acquisition device to acquire data representative of a first image;
cause the motion prediction circuitry to generate data indicative of a first pose of the image acquisition device in a three-dimensional space;
cause the motion prediction circuitry to acquire motion data indicative of a displacement of the image acquisition device in the three dimensional space;
cause the motion prediction circuitry to generate data indicative of a predicted second pose of the image acquisition device in the three-dimensional space at a second time (t₂);
generate data representative of a prospective second image using the data representative of the predicted second pose of the image acquisition device; and
cause the exposure determination circuitry to determine at least one auto-exposure parameter using the generated data representative of the prospective second image; and
at the second time t₂:
cause the image acquisition device to acquire data representative of a second image using the at least one determined auto-exposure parameter;
wherein the image acquisition device comprises an image acquisition device having a frame rate, and a difference between the first time (t₁) and the second time (t₂) is less than or equal to the frame rate of the image acquisition device.

2. (canceled)

3. The system of claim 1 wherein the motion prediction circuitry determines the predicted second pose of the image acquisition device at the second time (t₂) based on the acquired motion data and the first pose of the image capture device.

4. The system of claim 1 wherein the processor circuitry generates the data representative of the prospective second image based on the predicted second pose of the image acquisition device and the data representative of the first image.

5. The system of claim 1 wherein said one or more sensors comprises one or more motion sensors.

6. The system of claim 1 wherein the processor circuitry determines whether the image acquisition device is stationary by comparing the generated data indicative of a first pose of the image acquisition device with the generated data indicative of a predicted second pose of the image acquisition device.

7. The system of claim 6, wherein said storage device further comprises one or more data structures stored therein, said one or more data structures including auto-exposure parameters associated with the first pose of the image acquisition device.

8. The system of claim 7 wherein the exposure determination circuitry retrieves the at least one auto-exposure parameter from the data structure based on the first pose of the image acquisition device.

9. The system of claim 1 wherein the prospective second image and the first image at least partially overlap to provide:
an overlapped image portion that includes data representative of an image common to the first image and the prospective second image; and
at least one non-overlapped image portion including data representative of only the prospective second image.

10. The system of claim 9 wherein the exposure determination circuitry generates data representative of at least one content parameter associated with prospective second image content in the at least one non-overlapped image portion.

11. The system of claim 10 wherein the exposure determination circuitry generates data representative of at least one content parameter associated with prospective second image content in the at least one non-overlapped image portion by extrapolating the at least one content parameter for the prospective second image content in the at least one non-overlapped image portion using the data representative of the first image.

12. The system of claim 10, further comprising at least one ambient sensor communicably coupled to the exposure determination circuitry, the at least one ambient sensor to generate data indicative of at least one ambient condition.

13. The system of claim 12:
wherein the at least one ambient sensor generates an output signal that includes data indicative of an ambient illumination level; and
wherein the exposure determination circuitry determines the at least one auto-exposure parameter using the data indicative of the ambient illumination level.

14. An odometric auto-exposure method, comprising:
acquiring, by an image acquisition device, data representative of a first image at a first time (t₁);
generating, at t₁, data indicative of a first pose of the image acquisition device in a three-dimensional space;
acquiring, at t₁, motion data indicative of a displacement of the image capture device in the three dimensional space;
generating data indicative of a predicted second pose of the image acquisition device in the three-dimensional space at a second time (t₂);
generating data representative of a prospective second image using the data representative of the predicted second pose of the image capture device;
determining at least one auto-exposure parameter using the generated data representative of the prospective second image; and
acquiring, at t₂, data representative of a second image using the image capture device and the at least one determined auto-exposure parameter;
wherein the image acquisition device has a frame rate, and a difference between the first time (t₁) and the second time (t₂) is less than or equal to the frame rate.

15. (canceled)

16. The method of claim 14 wherein generating data indicative of a predicted second pose of the image acquisition device in the three-dimensional space at a second time (t₂) comprises:
generating data indicative of the predicted second pose of the image acquisition device in the three-dimensional space at the second time (t₂) using at least the acquired motion data and the first pose of the image acquisition device.

17. The method of claim 14 wherein generating data representative of a prospective second image comprises:
generating data representative of a prospective second image using the data representative of the predicted second pose of the image acquisition device and the data representative of the first image.

18. The method of claim 14, further comprising:
determining whether the image acquisition device is stationary by comparing the generated data indicative of a first pose of the image acquisition device with the generated data indicative of a predicted second pose of the image acquisition device.

19. The method of claim 18 wherein determining at least one auto-exposure parameter using the generated data representative of the prospective second image comprises:
retrieving the at least one auto-exposure parameter based on the first pose of the image acquisition device responsive to a determination that the image acquisition device is stationary.

20. The method of claim 14, further comprising, responsive to a determination that the image acquisition device is not stationary:
determining an overlapped image portion that includes data representative of an image common to the first image and the prospective second image; and
determining at least one non-overlapped image portion including data representative of only the prospective second image.

21. The method of claim 20 wherein determining at least one auto-exposure parameter using the generated data representative of the prospective second image comprises:
generating data representative of at least one content parameter associated with prospective second image content in the at least one non-overlapped image portion.

22. The method of claim 21 wherein generating data representative of the at least one content parameter associated with prospective second image content in the at least one non-overlapped image portion comprises:
generating data representative of at least one content parameter associated with prospective second image content in the at least one non-overlapped image portion by extrapolating the at least one content parameter for the prospective second image content in the at least one non-overlapped image portion using the acquired data representative of the first image.

23. The method of claim 21, further comprising:
generating data indicative of at least one ambient condition using at least one ambient sensor communicably coupled to the exposure determination circuitry.

24. The method of claim 23:
wherein generating data indicative of at least one ambient condition using at least one ambient sensor communicably coupled to the exposure determination circuitry comprises receiving data indicative of an ambient illumination level from a communicably coupled ambient sensor; and
wherein determining at least one auto-exposure parameter comprises determining at least one auto-exposure parameter using the received data indicative of the ambient illumination level.

25. A non-transitory computer readable medium that includes one or more instruction sets that when executed by processor circuitry cause the processor circuitry to:
at a first time (t₁):
cause a communicably coupled image acquisition device to acquire data representative of a first image;
cause motion prediction circuitry to generate data indicative of a first pose of the image acquisition device in a three-dimensional space;
cause the motion prediction circuitry to acquire motion data indicative of a displacement of the image acquisition device in the three dimensional space;
cause the motion prediction circuitry to generate data indicative of a predicted second pose of the image acquisition device in the three-dimensional space at a second time (t₂);
generate data representative of a prospective second image within a second field of view using the data representative of the predicted second pose of the image acquisition device; and
cause the exposure determination circuitry to determine at least one auto-exposure parameter using the generated data representative of the prospective second image; and
at the second time t₂:
cause the image acquisition device to acquire data representative of a second image using the at least one determined auto-exposure parameter;
wherein the image acquisition device has a frame rate, and a difference between the first time (t₁) and the second time (t₂) is less than or equal to the frame rate.
